(19) United States
(12) Patent Application Publication
(10) Pub. No.: US 2005/0259634 A1
(43) Pub. Date: Nov. 24, 2005

(54) Method and apparatus for low-overhead service availability and performance monitoring

(76) Inventor: Perry R. Ross, Englewood, CO (US)

Correspondence Address: BAKER BOTTS L.L.P., 2001 ROSS AVENUE, SUITE 600, DALLAS, TX, 75201-2980, US

(21) Appl. No.: 11/132,607

(22) Filed: May 18, 2005

Related U.S. Application Data
(60) Provisional application No. 60/572,600, filed on May 19, 2004.

(51) Int. Cl. H04L 12/26

(52) U.S. Cl. 370/351; 370/248

(57) ABSTRACT

Methods and apparatuses for low-overhead service availability and performance monitoring are provided. A contact attempt is sent to a machine running a service being monitored and associated with a port in the machine. A status of the service is updated as being unavailable, if no response is received within a predetermined period of time, and is updated based on the response, if the response is received within a predetermined period of time. If the response is an acknowledgment from the machine to proceed with a contact attempt for connecting to the port, the contact attempt is disconnected.

### CROSS REFERENCE TO RELATED APPLICATION

This application claims the benefit of U.S. provisional application Ser. No. 60/572,600, filed May 19, 2004 and entitled “USING STEALTH INTRUSION TECHNIQUE FOR LOW-OVERHEAD SERVICE AVAILABILITY AND PERFORMANCE MONITORING”.

### TECHNICAL FIELD

The present disclosure relates to computer network services and, more specifically, to using stealth intrusion techniques to monitor network services.

### DESCRIPTION OF THE RELATED ART

A network service typically waits for clients to connect on a port whose number is agreed upon in advance. For example, web servers usually listen on port 80, so when a web browser is directed to fetch a web page from a particular site, the browser sends a request to port 80 on that site. If the owner of that site wanted to monitor his web server's availability and response time, he may connect to port 80 periodically to ensure the web service is responding. If the connection failed, he would know that the service had stopped, and could take corrective actions. This, approach, however, may limit the number of ports that can be monitored within a given interval of time since establishing a connection to each monitored port consumes certain amount of time.

In addition, each connection to a monitored port consumes resources on both the machine running the connecting software (the “agent machine”) as well as the machine being monitored. Thus, if a large number of ports are being monitored, the agent machine may intermittently run out of resources. Furthermore, making a connection to a service, then abruptly disconnecting it, may trigger error log entries on the monitored machines. Thus, for instance, if a port is monitored every 60 seconds, quite a large number of error messages may result.

Accordingly, a less intrusive method is desirable for monitoring network services, for instance, to provide the ability to know what network services are enabled and disabled on a host computer, to determine service availability changes, and to monitor the response time of the service.

### SUMMARY

This application describes methods and apparatuses for low-overhead service availability and performance monitoring.

A method for low-overhead service availability and performance monitoring, according to an exemplary embodiment, includes (a) sending a contact attempt to a machine running a service being monitored, the service being associated with a port in the machine, (b) updating a status of the service as being unavailable, if no response is received within a predetermined period of time, and (c) updating the status of the service based on the response, if the response is received within a predetermined period of time. If the response is an acknowledgment from the machine to proceed with the contact attempt for connecting to the port, the contact attempt is disconnected.

According to another exemplary embodiment, a method for low-overhead service availability and performance monitoring can include (i) sending a one or more requests to test reachability of a machine and waiting for a reply, (ii) updating a status of a service running on a port on the machine as being unavailable, if it is determined that the machine is not reachable, (iii) sending a message packet to the machine to reach a port running a service being monitored, if it is determined that the machine is reachable, (iv) updating the status of the service as being unavailable, if the machine replies with a reset packet, and (v) updating the status of the service as being available, if the machine replies with an acknowledgment.

An apparatus for low-overhead service availability and performance monitoring, according to an exemplary embodiment, includes a module operable to prepare and send a communication request to a machine on a network, to contact a service on a port on the machine while mitigating intrusiveness on the host machine. The module updates a status of the service as being unavailable, if no response is received within a predetermined period of time, and updates the status of the service based on the response, if the response is received within a predetermined period of time. If the response is an acknowledgment from the machine to proceed with a contact attempt for connecting to the port, the contact attempt is disconnected.

The methods and apparatuses of this disclosure may be embodied in one or more computer programs stored on a computer readable medium or program storage device and/or transmitted via a computer network or other transmission medium in one or more segments or packets.

### BRIEF DESCRIPTION OF THE DRAWINGS

The features of the present application can be more readily understood from the following detailed description with reference to the accompanying drawings wherein:

FIG. 1A shows a flow diagram corresponding to a method for low-overhead service availability and performance monitoring, according to an exemplary embodiment;

FIG. 1B shows a flow diagram corresponding to a method for low-overhead service availability and performance monitoring, according to another exemplary embodiment;

FIG. 2A shows a flow diagram corresponding to a method for low-overhead service availability and performance monitoring, according to a third exemplary embodiment;

FIG. 2B is a flow diagram corresponding to a method for low-overhead service availability and performance monitoring, according to a fourth exemplary embodiment which uses a half open or SYN scan technique;

FIG. 3 illustrates an example of header information for TCP/IP;

FIG. 4 is a schematic diagram corresponding to a sliding window technique, according to an exemplary embodiment;

FIG. 5 is a schematic diagram corresponding to a system, according to an exemplary embodiment of the present disclosure; and

FIG. 6 shows an example of a computer system capable of implementing the methods and apparatuses of the present disclosure.

### DETAILED DESCRIPTION

In describing the preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

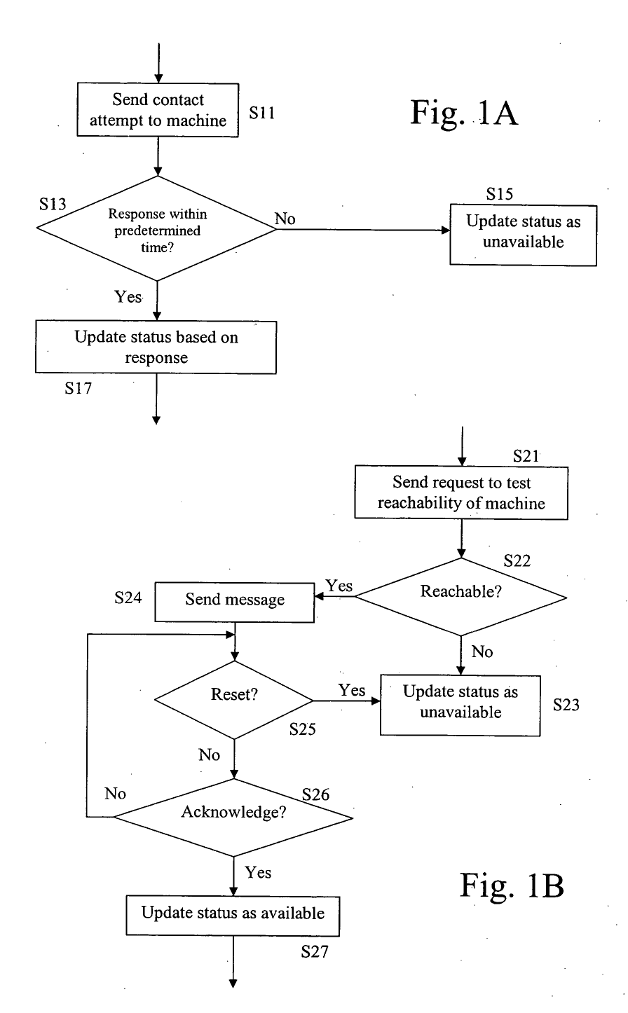

A method for low-overhead service availability and performance monitoring, according to an exemplary embodiment (FIG. 1A), is discussed below. A contact attempt is sent to a machine running a service being monitored and associated with a port in the machine (step S11). Time and response are monitored (step S13). A status of the service is updated as being unavailable (step S15), if no response is received within a predetermined period of time (step S13, No), and is updated based on the response (step S17), if the response is received within a predetermined period of time (step S13, Yes). If the response is an acknowledgment from the machine to proceed with a contact attempt for connecting to the port, the contact attempt is disconnected.

A method for low-overhead service availability and performance monitoring, according to another exemplary embodiment (FIG. 1B), can include sending one or more requests to test reachability of a machine and waiting for a reply (step S21). If it is determined that the machine is not reachable (step S22, No), a status of a service running on a port on the machine is updated as being unavailable (step S23). If it is determined that the machine is reachable (step S22, Yes), a message packet is sent to the machine to reach a port running a service being monitored (step S24). If the machine replies with a reset packet (step S25, Yes), the status of the service is updated as being unavailable (step S23). If the machine replies with an acknowledgment (step S26, Yes), the status of the service is updated as being available (step S27).

Monitoring methods and apparatuses, according to some exemplary embodiments of the present disclosure, use techniques that are less intrusive and/or “intrusion mitigating” for contacting a network service to determine the availability and/or status of that service. These less intrusive or intrusion mitigating techniques, for example, do not generate significant network activity or excessive error log messages. Such techniques may initially attempt to establish a contact with a port of a service being monitored and as soon as the status of that port is determined, the contact attempt may be aborted. The status, for example, may be determined from a host running that service. The host may send an initial acknowledgment for contacting that port and may depend on the communications protocols used between the monitoring system and the system being monitored. Thus, for example, the actual connection to the service being monitored need not be completed in order to determine the status of that service. This results in a less intrusive way of determining the service availability and monitoring performance.

Examples of such methods may include stealth port scan techniques that may be utilized by intruders, for example hackers. During a stealth port scan, an intruder determines services that are active. The intruder may begin to focus attacks on any services he suspects are vulnerable. While locating vulnerable services, the attacker may seek to avoid engaging in activity that may appear suspicious and thus alert the victim to the pending attack. Since establishing connections to all of a machine's active services can generate noticeable network activity, error log messages, and other unwelcome attention, the intruder may utilize techniques to test for running services without actually completing a connection to the port on which the service is running.

Some of these techniques work by exploiting “quirks” in the communication method that the network services use, for example TCP/IP (transfer control protocol/internet protocol). An attacker may therefore reveal whether a connection would succeed without actually establishing the connection. This may be accomplished, for example, by starting to negotiate a connection, but aborting it by sending a “reset” packet in place of a final acknowledgment packet. Alternatively, the connection may be completed and the true origin of the connection may be masked. This may be accomplished, for example, by falsifying the source address or by taking over a third machine, known as a “zombie”, and using it to initiate the connection.

In one exemplary embodiment, one or more stealth scan techniques is utilized to verify port status, for example, to monitor availability and performance. Generally, every network service has a matching port, and if the service is running, the port will accept network connections. Conversely, if the network service is not active, connection attempts to that service's port will fail. Thus, attempting a connection to the port provides sufficiently accurate indication of the availability of the service on the monitored host. Even if the service performs authentication such as checking a password, and rejects service for a particular connection, it does this only after the connection has been made.

Some examples of stealth scan techniques include SYN scan (also referred to as “half-open scan”), FIN scan, XMAS scan, Null scan, FTP bounce scan, and Idle scan (also referred to as “zombie scan”).

The SYN scan technique, for example, sends a packet that mimics the creation of a normal connection, and inspects the reply packet from the monitored host. If the port is closed, the host will send a rejection (RST) packet. If the port is open, the reply will be an SYN ACK (acknowledgment) packet, to which the normal reply would be an ACK (at which point the connection would be open). Instead, the SYN scan returns a RST packet, which aborts the connection.

The FIN scan technique sends a FIN packet (normally used to close connections) to the port being probed. Because of the design of TCP/IP, open ports ignore this packet, whereas closed ports reply with a rejection (RST) packet. This technique is useful for operating systems that implement the TCP/IP standards in their network stack implementation. The XMAS scan is similar to the FIN scan, but sets additional TCP flag bits in an attempt to survive firewall filtering. The Null scan is also similar to the FIN scan, but uses no flag bits at all.

FTP bounce scan directs an FTP (file transfer protocol) server to connect to the specified port. Idle scan (or “zombie scan”) uses a third machine. This third machine increments its IPID (Internet packet identification number) in a predictable way and remains idle in order to be a useful zombie host for this scan. By impersonating a host (that is, sending connection packets in the third machine's name), then interrogating the third machine's IPID, it can be determined whether the third machine received a positive or negative response to the connection packet. The examples described above are only a partial list of stealth scan techniques. Other stealth scan techniques, which determine if a port is open, for example, without making a full connection, may also be used to determine availability and performance monitoring.

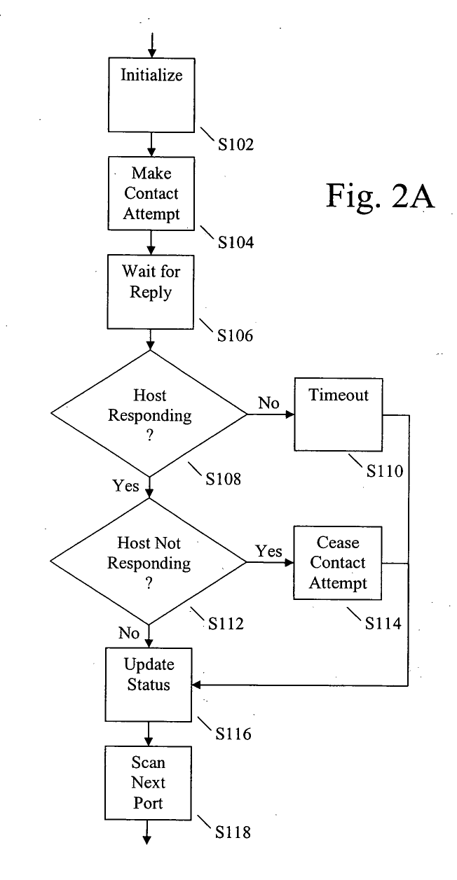

FIG. 2A is a flow chart corresponding to another exemplary embodiment. According to this embodiment, one or more stealth intrusion techniques, for example as described above, are used to monitor network services, while keeping the impact on the network and the monitored host to a minimum. While one technique is described in detail in conjunction with the system and method of the present disclosure, it should be understood that the system and method of the present disclosure is not limited to using the particular stealth intrusion technique described.

Parameters and objects are initialized for attempting to connect to one or more hosts (Step S102) For example, one or more hosts and port numbers for scanning may be determined at this stage. The initialization stage may also include, for example, depending on the stealth intrusion technique used, setting a maximum number of hosts to scan at a given period of time.

A connection attempt may be made to a selected port number at a select host (Step S104). A reply from the select host may be received or expected to be received (Step S106). For example, if the selected host does not reply (No, Step S108), for example, because the selected host is down or unavailable, within, for example, a predetermined period of time, the method may time out (Step S110) and proceeds to update the status of this port (Step S116)

If the selected host does reply (Step S108, Yes) and if the selected host replies that the port number is closed or otherwise unavailable (Step 112, No), the method proceeds update the status of this port (Step S116). In this case the status would be updated as being unavailable. If the selected host replies that the port is available (Step S112, Yes) and thus, the selected host acknowledges the connection attempt or otherwise proceeds to complete the connection, the connection attempt is caused to abort (Step S114). After the status has been updated (Step S116) the scan of next port is attempted (Step S118).

FIG. 2B is a flow chart corresponding to another exemplary embodiment which utilizes a half open or SYN scan technique. Usual initialization may be performed to set various parameters used for attempting to make a connection (Step S202). A packet that simulates a request to open a connection on a selected port of a selected host may be prepared (Step S204).

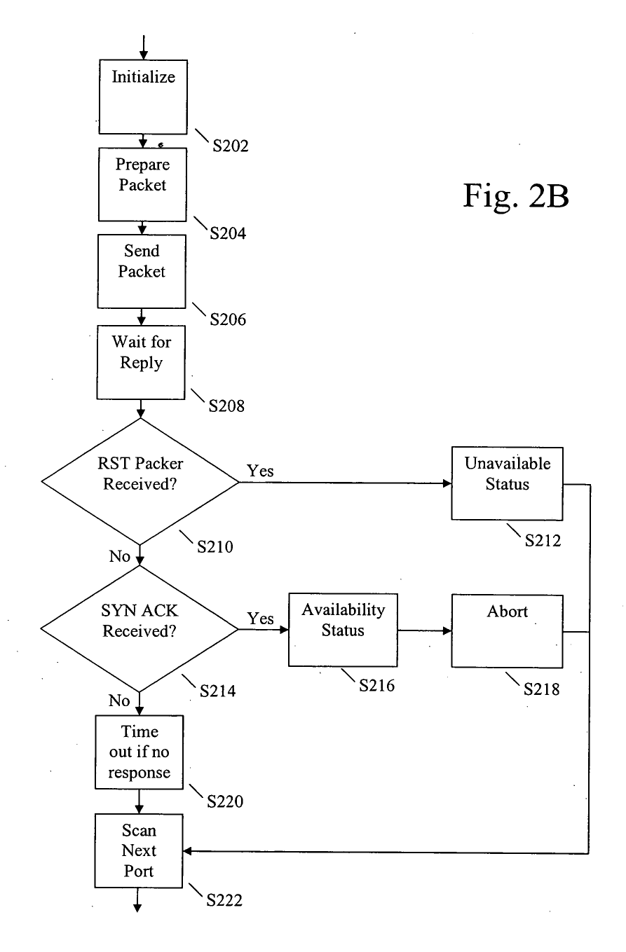

For example, networks may exchange information in the form of packets, or clusters of data. The data may be sent along with the metadata needed to deliver that data reliably to the recipient. This metadata is normally prepended to the data, and is commonly referred to as “headers.” Additionally, one network protocol may be layered above another, lower-level protocol. TCP/IP, for example, is based on this layered schema. Here TCP is a higher-level protocol layered above IP. FIG. 3 illustrates an example of the header information for TCP 302 and IP 304. This is commonly referred to as a “protocol stack.” As data is passed down the protocol stack, each layer adds its header information to the data and headers received from the higher-level protocols. Thus, a TCP/IP packet will begin with the IP header and then follow with the TCP header. Application data, where it exists may then follow.

In one exemplary embodiment, available network Library-functions provided by an operating system for preparing to make a connection need not be used. This is because the operating system may insist on completing the connection. The packet is prepared (Step S204), for example, by setting the SYN flag in the TCP flags field. Additionally, other values used or set in the TCP/IP header (FIG. 3) may be used.

Referring back to FIG. 2, a packet that simulates a request to open a connection on a selected port of a selected host may be sent. (Step S206). The SYN packet sent to the host being monitored may elicit a response from the host. If the port is closed, indicating the service is not running, the remote host may reply with a RST (reset) packet. This is a packet with the RST flag set in the TCP flags field (FIG. 3). If the port is open, indicating that the service being monitored is available, the remote host may reply with a SYN ACK packet, acknowledging the SYN packet sent.

Thus, if an RST packet is received (Step S210, Yes), the status of the monitored service associated with the port may be updated as being unavailable (Step S212). If an RST packet is not received (Step S210, No) and if SYN ACK packet is received (Step S214, Yes), then the status of the monitored service associated with the port may be updated as being available (Step S216). The connection attempt not yet completed may be aborted (Step S218), for example, by sending an RST packet. According to one exemplary embodiment, an RST packet need not be explicitly sent out where the operating system, unaware that a SYN packet was sent, sees the received SYN ACK reply from the selected host and treats it as an unsolicited packet. Seeing the SYN ACK reply as an unsolicited packet, the operating system may then reply with an RST packet, as the TCP protocol would dictate.

If no response comes back from the selected host after the SYN packet is sent, a time out may occur after a predetermined period of waiting time (Step S220). This may complete the half-open scan, and thus the availability or unavailability of a service at a port may be monitored without having awakened the service. A scan of the next port may then be attempted (Step S222).

According to another exemplary embodiment, a large number of services may be monitored. For example, the SYN packets may be sent in close succession, and then wait for the replies to arrive. This may speed up the process of scanning the ports, for example by many times. In sending the SYN packets to a number of ports, a prudent number of ports to send the SYN packet may be selected so that the risk of exhausting the resources on either the host being monitored or the host running the scan is minimized.

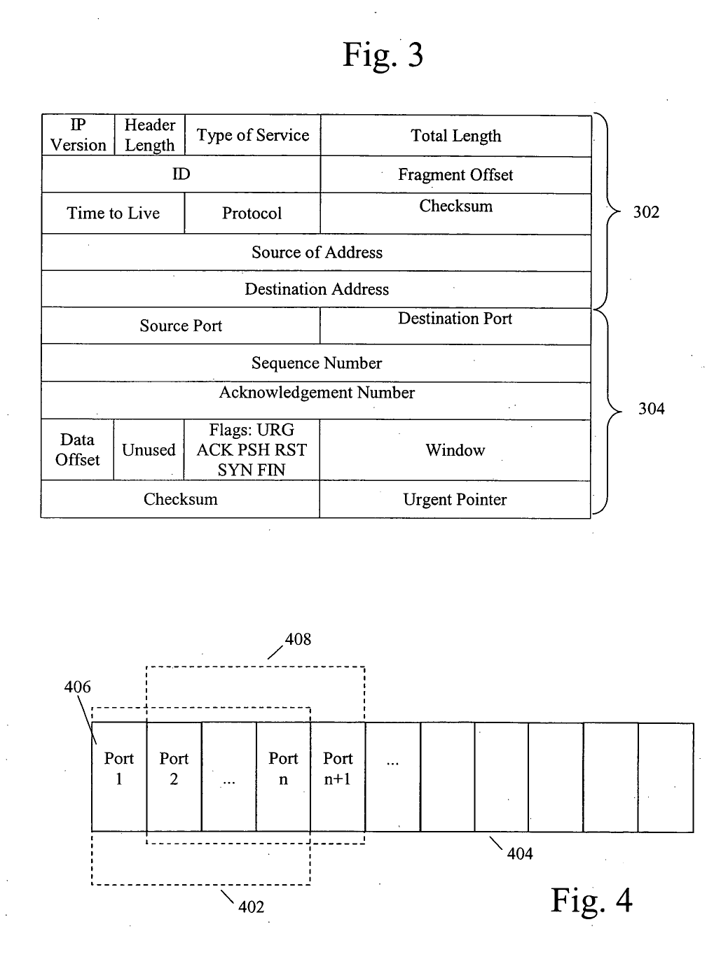

According to another exemplary embodiment, the number of outstanding SYN packets may be set to a predetermined number, for example, 20. This may be done, for example, using a “sliding window” algorithm shown in FIG. 4, in which a window 402 of a predetermined size, for example, 20 is placed over the list of ports 404 to be monitored. The individual ports 406 inside the window 402 may then be sent SYN packets. As the scan of the lowest-numbered port is completed, the window 402 may advance 408 past this port and allows subsequent ports to be scanned. In another exemplary embodiment, a maximum number of ports to send SYN packets may be set, and when that maximum number is reached, SYN is not sent to another port until any one or ports in the maximum number has completed its scan.

As described above, testing ports on a machine or a host that is down or disconnected from the network may not return a reply. A timeout mechanism may prevent having to wait indefinitely for a reply. In addition, before sending the packet (FIG. 2, Step S206) a ping (packet internet groper) of the host being monitored may be performed to determine, for example, whether the host is connected to the network. If the host does not respond to the initial ping, the port connection attempt is not made for checking the service availability on this host.

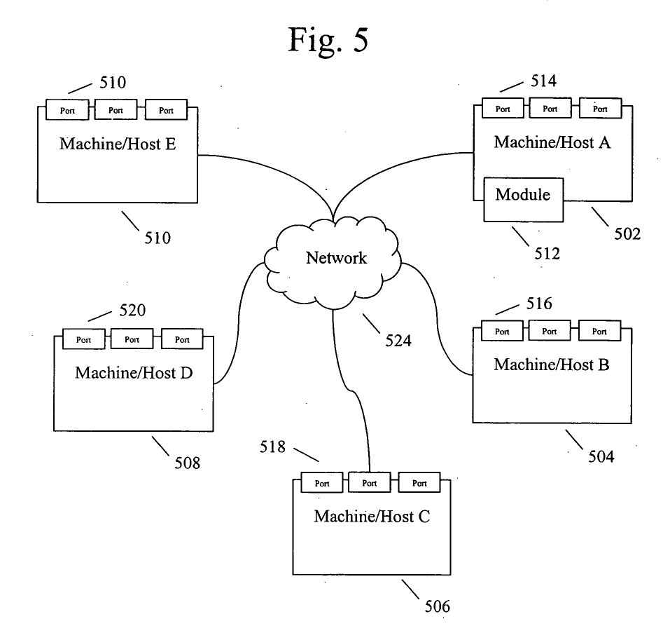

FIG. 5 is a schematic diagram illustrating a system according to an exemplary embodiment. A plurality of hosts and/or machines may exist in a network. Each machine may includes one or more services assigned associated ports (for example, 514 for machine A 502, 516 for machine B 504, 518 for machine C 506, 520 for machine D 52 0, 522 for machine E 522, etc.) for running the services. Machine A 502, for example, may include a module 512 for determining availability of services using one or more of the stealth intrusion techniques described above. Machine A 502, for example using the module 512, may attempt to establish a connection according to the method described above, to one or more of the ports 516, 518, 520 and 522 associated with any one of the machines 504, 506, 508 and 510 in the network. The contacted machines 504, 506, 508 and 510 may acknowledge, reject, or not respond at all to the connection attempts, as described above, and the module 512 may update the status of the ports according to the response or non-response from the contacted machines 504, 506, 508 and 510 as described above with reference to FIGS. 1 and 2.

In one exemplary embodiment, a measurement of the time the remote host takes to respond to the connection attempt can be used in performance monitoring. For example, the time required for the connection attempt to be transmitted over the network, the monitored host to reply to the connection attempt, and/or the reply to be transmitted back over the network can be measured and used in performance monitoring.

The systems and methods of the present disclosure may be implemented and executed on a general-purpose computer. The embodiments described above are illustrative examples and it should not be construed that the present invention is limited to these particular embodiments. For example, although the techniques used for making connection attempts were described with reference to a set of stealth intrusion techniques, other techniques that are not intrusive or less intrusive on a system being monitored may be used. Other techniques may be selected depending on the type of communication protocol used in the network of systems being monitored and how that communication protocol operates. Thus, various changes and modifications may be effected by one skilled in the art without departing from the spirit or scope of the invention as defined in the appended claims.

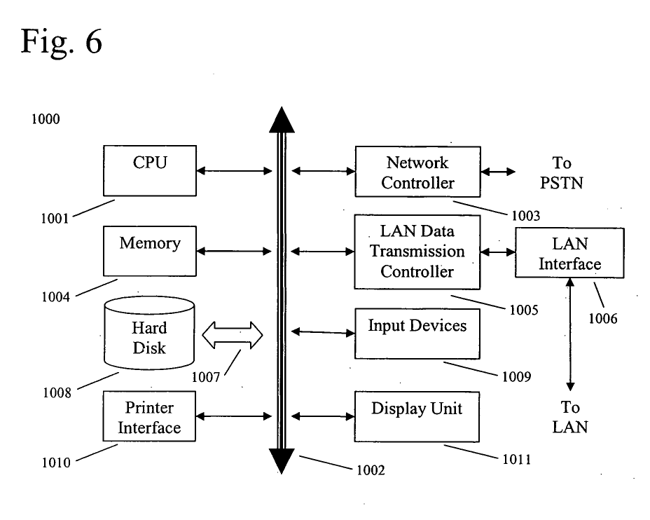

FIG. 6 shows an example of a computer system which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The specific embodiments discussed herein are illustrative, and many additional modifications and variations can be introduced on these embodiments without departing from the spirit of the disclosure or from the scope of the appended claims. For example, elements (such as steps) and/or features of different illustrative embodiments may be combined with each other and/or substituted for each other within the scope of this disclosure and appended claims.

Additional variations may be apparent to one of ordinary skill in the art from reading U.S. provisional application Ser. No. 60/572,600, filed May 19, 2004, the entire contents of which are incorporated herein by reference.

1. A method for low-overhead service availability and performance monitoring, comprising:
(a) sending a contact attempt to a machine running a service being monitored, the service being associated with a port in the machine;
(b) updating a status of the service as being unavailable, if no response is received within a predetermined period of time; and
(c) updating the status of the service based on the response, if the response is received within a predetermined period of time, wherein if the response is an acknowledgment from the machine to proceed with the contact attempt for connecting to the port, the contact attempt is disconnected.

2. The method of claim 1, further comprising updating the status of the service as being unavailable, if the response from the machine is a reset message.

3. The method of claim 1, further comprising updating the status of the service as being available, if the response from the machine is an acknowledgment to continue with the contact attempt.

4. The method of claim 1, wherein the contact attempt includes an intrusion mitigating procedure in a selected communication protocol that provides an indication of whether the service being monitored is connectable.

5. The method of claim 1, wherein the contact attempt includes an intrusion mitigating procedure in a selected communication protocol that provides an indication of whether the service being monitored is connectable without completing a connection to the port.

6. The method of claim 1, wherein the contact attempt includes using one or more stealth intrusion techniques.

7. The method of claim 6, wherein the one or more stealth intrusion techniques comprise SYN scan, FIN scan, XMAS scan, Null scan, FTP bounce scan, Idle scan, or combinations thereof.

8. The method of claim 1, wherein the contact attempt includes sending a communications packet for closing a connection to the service.

9. The method of claim 1, wherein the contact attempt includes sending an initial communications packet to establish a connection to the port on the machine, the initial communications packet eliciting one or more responses from an operating system running on the machine that indicate whether the service is available.

10. The method of claim 1, further comprising sending one or more requests to test reachability of the machine and waiting for a reply, and updating the status of the service as unavailable and not sending the contact attempt to the machine in (a), if it is determined that the machine is not reachable.

11. The method of claim 10, wherein the one or more requests include a ping.

12. The method of claim 1, further including measuring duration of time between the contact attempt and the response.

13. A computer system comprising:
a processor; and
a program storage device readable by the computer system, tangibly embodying a program of instructions executable by the processor to perform the method claimed in claim 1.

14. A program storage device readable by a machine, tangibly embodying a program of instructions executable by the machine to perform the method claimed in claim 1.

15. A computer data signal transmitted in one or more segments in a transmission medium which embodies instructions executable by a computer to perform the method claimed in claim 1.

16. A method for low-overhead service availability and performance monitoring, comprising:
sending one or more requests to test reachability of a machine and waiting for a reply;
updating a status of a service running on a port on the machine as being unavailable, if it is determined that the machine is not reachable;
sending a message packet to the machine to reach a port running a service being monitored, if it is determined that the machine is reachable;
updating the status of the service as being unavailable, if the machine replies with a reset packet; and
updating the status of the service as being available, if the machine replies with an acknowledgment.

17. An apparatus for low-overhead service availability and performance monitoring, comprising:
a module operable to prepare and send a communication request to a machine on a network, to contact a service on a port on the machine while mitigating intrusiveness on the host machine,
wherein the module updates a status of the service as being unavailable, if no response is received within a predetermined period of time, and updates the status of the service based on the response, if the response is received within a predetermined period of time, and wherein if the response is an acknowledgment from the machine to proceed with a contact attempt for connecting to the port, the contact attempt is disconnected.

18. The apparatus of claim 17, wherein the network includes a TCP/IP network and the reply includes at least an acknowledgment or a reset message.

19. The apparatus of claim 17, further comprising a sliding window module for controlling the sending of the communication request to a predetermined number of ports.

20. The apparatus of claim 17, wherein the module measures a duration of time between the communication request and the reply.
